(19) United States
(12) Patent Application Publication
(10) Pub. No.: US 2026/0354351 A1
(43) Pub. Date: Nov. 12, 2026

(54) CANINE BITE PREVENTION SYSTEM AND METHOD

(71) Applicant: Jeb A Carlson, Mandan, ND (US)

(72) Inventor: Jeb A Carlson, Mandan, ND (US)

(21) Appl. No.: 19/199,684

(22) Filed: May 6, 2025

(51) Int. Cl. A01K 25/00

(52) U.S. Cl. CPC A01K 25/00

(57) ABSTRACT

A canine bite prevention system may include dental posts and removable bands. The dental posts may be configured for attachment to a dog's upper and lower premolar teeth. The posts may be cemented or mechanically fastened to the teeth. Removable silicone rubber bands may connect between corresponding upper and lower posts. The bands may limit the maximum opening of the dog's mouth while allowing normal functions like breathing, drinking, and panting. The system may include an installation kit having posts, dental cement, measurement tools, and instructions. A temporary muzzle may be provided for initial installation. The posts may be semi-permanently mounted while enabling easy attachment and detachment of the bands. The system may maintain normal aesthetic appearance of the dog. The bands may be replaceable and may permit partial mouth opening while preventing full bite force. The system may be installed by a veterinarian or self-installed by an owner.

### BACKGROUND

The present disclosure relates generally to animal control devices and more particularly to systems and methods for preventing aggressive biting behavior in canines.

Traditional approaches for preventing dog bites have included various types of muzzles and head-mounted restraints. Such devices may cause anxiety in both the animal and observers. Additionally, conventional muzzles may restrict normal behaviors like panting, drinking, and breathing.

### BRIEF SUMMARY

In accordance with various embodiments, a canine bite prevention system may include dental posts configured for attachment to a canine's teeth and removable bands that connect between the posts to limit jaw opening while allowing normal functions.

The following description provides exemplary embodiments only, and is not intended to limit the scope, applicability, or configuration of the disclosure. Rather, the following description of exemplary embodiments will provide those skilled in the art with an enabling description for implementing one or more exemplary embodiments. Various changes may be made in the function and arrangement of elements without departing from the spirit and scope of the disclosure.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 illustrates components of an exemplary canine bite prevention system according to various embodiments.

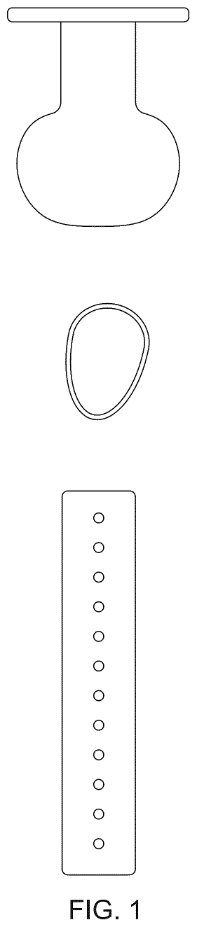

### DETAILED DESCRIPTION

In the following detailed description, numerous specific details are set forth to provide a thorough understanding of the embodiments disclosed herein. However, it will be understood by those skilled in the art that the principles disclosed herein may be practiced without these specific details. In some instances, well-known methods, procedures, components, and circuits have not been described in detail so as not to obscure the embodiments disclosed herein. It is to be understood that the embodiments described herein may be used as a basis for designing or modifying other structures for carrying out the same purposes of the present disclosure. It should also be recognized that the embodiments described herein may be implemented in various forms including hardware, software, firmware, or combinations thereof.

A bite prevention system for canines may include one or more dental posts. The dental posts may be formed from stainless steel. Each dental post may include a base portion and a protruding portion. The base portion may be configured for attachment to a tooth surface. The protruding portion may extend outwardly from the base portion.

The dental posts may be attachable to premolar teeth. A first dental post may be attachable to an upper premolar tooth on a first side of a mouth. A second dental post may be attachable to a lower premolar tooth on the first side of the mouth. A third dental post may be attachable to an upper premolar tooth on a second side of the mouth. A fourth dental post may be attachable to a lower premolar tooth on the second side of the mouth.

The dental posts may be secured to the teeth using dental cement. The dental cement may form a permanent bond between the base portion of each dental post and the corresponding tooth surface. Alternatively, the dental posts may be secured by drilling into the teeth and mechanically fastening the posts.

The system may include one or more elastic bands. The elastic bands may be formed from silicone rubber material. Each elastic band may include first and second openings. The first opening may be configured to engage with an upper dental post. The second opening may be configured to engage with a lower dental post.

A first elastic band may extend between the first and second dental posts on the first side of the mouth. A second elastic band may extend between the third and fourth dental posts on the second side of the mouth. The elastic bands may be removably attachable to the protruding portions of the dental posts.

The elastic bands may limit a maximum opening distance of the mouth while allowing normal mouth functions. The elastic bands may stretch to permit partial opening of the mouth for breathing, drinking, and panting. The elastic bands may prevent full opening of the mouth required for aggressive biting.

An installation kit may include the dental posts, dental cement, elastic bands, measuring tape, and drill bit. The kit may include instructions for proper installation and use of the system components.

The protruding portion of each dental post may include a rounded head portion. The rounded head portion may have a smooth, curved outer surface. The smooth outer surface may minimize irritation to surrounding mouth tissue. The rounded head portion may include a circumferential groove. The circumferential groove may be configured to receive and retain an elastic band.

The base portion of each dental post may include a flat bottom surface. The flat bottom surface may maximize contact area with the tooth surface. The base portion may include a textured surface pattern. The textured surface pattern may enhance bonding with the dental cement. The base portion may include one or more mechanical retention features. The mechanical retention features may include grooves, channels, or surface roughening.

When using the drill-in attachment method, the base portion may include a threaded shaft. The threaded shaft may be configured to engage with a drilled hole in the tooth. The threaded shaft may provide mechanical retention of the dental post. The drilled hole may extend partially through the tooth. The depth of the drilled hole may be controlled to avoid damage to the tooth root.

The elastic bands may be provided in different sizes. The different sizes may accommodate various mouth sizes and bite force requirements. The elastic bands may be color-coded according to size or strength. The elastic bands may include size or strength indicators molded into the material. The elastic bands may be packaged in sealed containers to maintain cleanliness.

The measuring tape included in the installation kit may be used to determine appropriate elastic band size. The measuring tape may include markings corresponding to different elastic band sizes. The drill bit included in the kit may be sized appropriately for creating pilot holes in teeth. The drill bit may include depth control features to prevent excessive drilling depth.

The elastic bands may provide several functional benefits compared to traditional bite prevention methods. The elastic properties of the silicone rubber material may allow controlled stretching during normal mouth movements. This controlled stretching may enable essential functions like breathing, drinking water, and thermoregulation through panting. The elastic resistance may gradually increase as the mouth opens wider, providing a natural limiting effect on bite force.

The strategic placement of the dental posts on the premolar teeth may leverage mechanical advantage principles. The posts may be positioned to optimize the mechanical resistance provided by the elastic bands. This optimization may allow relatively small elastic forces to effectively restrict aggressive biting motions. The premolar location may minimize interference with normal mouth functions while maximizing bite prevention effectiveness.

The rounded, smooth surfaces of the dental posts may reduce tissue irritation and promote acceptance by the canine. The circumferential grooves in the post heads may securely retain the elastic bands while allowing quick attachment and removal. The textured base surfaces may enhance cement bonding strength for reliable long-term attachment. These design features may contribute to both functional effectiveness and comfort.

The system components may be provided in various sizes to accommodate different breeds and mouth geometries. The measuring tape included in the installation kit may enable proper sizing of both posts and elastic bands. Color coding of elastic bands may simplify selection of appropriate sizes and strengths. Clear installation instructions may help ensure optimal placement and attachment of system components.

The stainless steel construction of the posts may provide durability and biocompatibility. The posts may resist corrosion and wear in the oral environment. The silicone rubber elastic bands may maintain consistent elastic properties over time. The dental cement may form strong, permanent bonds between posts and teeth. These material choices may contribute to reliable long-term performance.

The drill-in attachment method may provide an alternative installation option. The threaded post design may enable secure mechanical retention in the tooth structure. Depth control features may help prevent damage to tooth roots during installation. This method may be suitable when cement bonding may not be preferred.

The system may include design features to enhance both functional performance and user convenience. The dental posts may include beveled edges around the base portion. The beveled edges may help distribute mechanical stresses more evenly across the tooth surface. The protruding portions may taper gradually from the base to minimize tissue interference.

The elastic bands may incorporate reinforced openings. The reinforced openings may help prevent tearing during repeated attachment and removal. The elastic material thickness may vary across different regions of the bands. The variable thickness may optimize elastic response while maintaining durability.

The installation kit may include multiple sizes of drill bits. The different drill bit sizes may accommodate varying tooth sizes across different breeds. The kit may include depth stop collars for the drill bits. The depth stop collars may help prevent excessive drilling depth during mechanical post installation.

The dental cement may be provided in pre-measured quantities. The pre-measured quantities may help ensure proper mixing ratios. The cement may include a color indicator. The color indicator may change when the cement reaches its final cured state. The cement packaging may include mixing instructions with recommended working times.

The measuring tape may include breed-specific sizing guidelines. The sizing guidelines may help match appropriate elastic band sizes to different dog breeds. The tape may include markings for both metric and imperial measurements. The dual measurement system may enhance usability across different regions.

The system components may be packaged in sterile pouches. The sterile packaging may help maintain cleanliness during storage and handling. The pouches may include peel-away seals. The peel-away seals may facilitate easy access while maintaining sterility until use.

The installation instructions may include detailed diagrams. The diagrams may illustrate proper post placement locations on the teeth. The instructions may provide recommended elastic band sizes. The size recommendations may be based on breed weight ranges and jaw measurements.

The dental posts may incorporate orientation markers. The orientation markers may help ensure proper alignment during installation. The posts may include size indicators. The size indicators may be permanently marked on the base portions.

The elastic bands may feature grip surfaces. The grip surfaces may facilitate handling during attachment and removal. The bands may include wear indicators. The wear indicators may signal when replacement may be needed.

The system may accommodate different installation preferences. The cement bonding method may provide a non-invasive attachment option. The mechanical drill-in method may offer enhanced retention in certain situations. Both methods may achieve secure long-term fixation of the posts.

The dental posts may include additional structural features to enhance performance. The base portion of each post may include a series of microchannels. The micro-channels may increase surface area for cement bonding. The protruding portion may incorporate a flared section near the base. The flared section may help distribute mechanical forces.

The elastic bands may be manufactured with varying durometer ratings. The durometer ratings may correspond to different bite force requirements. The bands may incorporate stress distribution features. The stress distribution features may help prevent localized material fatigue.

The installation kit may include multiple cement formulations. The different formulations may accommodate varying moisture conditions. The kit may include surface preparation materials. The surface preparation materials may help ensure optimal cement adhesion.

The measuring tape may include anatomical reference points. The reference points may guide proper post placement locations. The tape may include breed-specific zones. The zones may correspond to recommended elastic band sizes.

The drill bits may incorporate depth-limiting features. The depth limits may prevent excessive tooth penetration. The bits may include orientation guides. The orientation guides may help maintain proper drilling angles.

The dental posts may be produced in different heights. The different heights may accommodate varying mouth geometries. The posts may include material composition markings. The composition markings may identify specific alloy grades.

The elastic bands may incorporate UV-resistant additives. The UV resistance may help maintain material properties. The bands may include antimicrobial compounds. The antimicrobial compounds may inhibit bacterial growth.

The system components may be packaged in procedure-specific kits. The procedure kits may include all materials needed for specific installation methods. The kits may include verification tools. The verification tools may confirm proper component selection.

The dental posts may feature polished surfaces. The polished surfaces may minimize plaque accumulation. The posts may incorporate identification codes. The identification codes may enable component tracking.

The elastic bands may be manufactured with reinforced regions. The reinforced regions may enhance durability at stress points. The bands may include orientation indicators. The orientation indicators may ensure proper installation alignment.

The system may include various adaptations and modifications which may be apparent to those skilled in the art. While specific embodiments have been described above, these descriptions may be considered as exemplary rather than limiting. The scope of protection sought may be defined by the appended claims. The described features, structures, characteristics, and methods may be combined in any suitable manner in one or more embodiments. Various modifications, changes, and variations which may be apparent to those skilled in the art may be made in the arrangement, operation, and details of the methods and systems disclosed herein without departing from the spirit and scope of the described embodiments.

The described bite prevention system may provide an effective solution for controlling canine bite potential while maintaining normal mouth functions. The system may utilize strategically positioned dental posts in combination with removable elastic bands. The base portions of the dental posts may incorporate various surface treatments and mechanical features to ensure secure attachment. The protruding portions may include carefully designed geometries to optimize band retention and minimize tissue interaction. The elastic bands may be manufactured with specific material properties and structural features to provide controlled jaw movement restriction. The installation methods may accommodate different clinical preferences through either cement bonding or mechanical attachment approaches. The system components may be provided in various sizes with appropriate measurement tools to ensure proper fit across different breeds. The materials selected for the components may provide durability and biocompatibility for long-term use. The installation kit contents may enable proper component selection and placement. The system may represent an advance in canine bite prevention by combining effective function with enhanced comfort and acceptance.

While several illustrative embodiments have been shown and described, numerous variations and alternative embodiments will occur to those skilled in the art. Such variations and alternative embodiments are contemplated and may be made without departing from the scope of the disclosure as defined in the appended claims.

What is claimed is:

1. A bite prevention system for a canine comprising:
a first dental post configured for attachment to an upper premolar tooth on a first side of a mouth;
a second dental post configured for attachment to a lower premolar tooth on the first side of the mouth;
a third dental post configured for attachment to an upper premolar tooth on a second side of the mouth;
a fourth dental post configured for attachment to a lower premolar tooth on the second side of the mouth;
a first elastic band comprising first and second openings configured to engage with the first and second dental posts respectively; and
a second elastic band comprising first and second openings configured to engage with the third and fourth dental posts respectively;
wherein the elastic bands are configured to limit a maximum opening distance of the mouth while allowing breathing, drinking, and panting.

2. The bite prevention system of claim 1, wherein each dental post comprises:
a base portion configured for attachment to a tooth surface; and
a protruding portion extending outwardly from the base portion.

3. The bite prevention system of claim 2, wherein the protruding portion comprises:
a rounded head portion having a smooth curved outer surface; and
a circumferential groove configured to receive and retain an elastic band.

4. The bite prevention system of claim 2, wherein the base portion comprises:
a flat bottom surface configured to contact the tooth surface; and
a textured surface pattern configured to enhance bonding with dental cement.

5. The bite prevention system of claim 1, wherein the dental posts comprise stainless steel.

6. The bite prevention system of claim 1, wherein the elastic bands comprise silicone rubber material.

7. The bite prevention system of claim 1, further comprising:
dental cement configured to secure the dental posts to the teeth.

8. The bite prevention system of claim 1, wherein:
each dental post comprises a threaded shaft configured to engage with a drilled hole in a tooth.

9. The bite prevention system of claim 1, wherein the elastic bands are provided in different sizes corresponding to different mouth sizes.

10. A method of installing a bite prevention system in a canine mouth comprising:
attaching a first dental post to an upper premolar tooth on a first side of the mouth;
attaching a second dental post to a lower premolar tooth on the first side of the mouth;
attaching a third dental post to an upper premolar tooth on a second side of the mouth;
attaching a fourth dental post to a lower premolar tooth on the second side of the mouth;
engaging a first elastic band between the first and second dental posts; and
engaging a second elastic band between the third and fourth dental posts.

11. The method of claim 10, wherein attaching each dental post comprises:
applying dental cement to a base portion of the dental post; and
bonding the base portion to a surface of the corresponding tooth.

12. The method of claim 10, wherein attaching each dental post comprises:
drilling a hole in the corresponding tooth; and
securing a threaded shaft of the dental post within the drilled hole.

13. The method of claim 10, further comprising:
measuring a mouth size of the canine; and
selecting elastic bands sized according to the measured mouth size.

14. An installation kit for a canine bite prevention system comprising:
four dental posts, each dental post comprising a base portion and a protruding portion;
dental cement configured to secure the dental posts to teeth;
multiple pairs of elastic bands configured to engage with the dental posts;
a measuring tape configured to determine appropriate elastic band size; and
instructions for installation and use of the system components.

15. The installation kit of claim 14, further comprising:
a drill bit configured to create holes in teeth for mechanical attachment of the dental posts.

16. The installation kit of claim 14, wherein:
the elastic bands comprise different sizes corresponding to different canine mouth sizes; and
the elastic bands are color-coded according to size.

17. The installation kit of claim 14, wherein each dental post comprises:
a rounded head portion having a smooth curved outer surface; and
a circumferential groove configured to receive and retain an elastic band.

18. The installation kit of claim 14, wherein:
the base portion of each dental post comprises a textured surface pattern configured to enhance bonding with the dental cement.

19. The installation kit of claim 14, wherein:
the base portion of each dental post comprises a threaded shaft configured to engage with a drilled hole in a tooth.

20. The installation kit of claim 14, wherein:
the dental posts comprise stainless steel; and
the elastic bands comprise silicone rubber material.
